(19) United States
(12) Patent Application Publication
(10) Pub. No.: US 2024/0148021 A1
(43) Pub. Date: May 9, 2024

(54) PATATIN-EMULSIFIED BINDER

(71) Applicant: Coöperatie Koninklijke Avebe U.A., Veendam (NL)

(72) Inventors: Nikola STANIŠIC, Groningen (NL); Zhenghong CHEN, Groningen (NL); Roelfina Willemina Antonia THÜRKOW, Assen (NL); Vani BHASKARAN, Groningen (NL)

(73) Assignee: Coöperatie Koninklijke Avebe U.A., Veendam (NL)

(21) Appl. No.: 18/279,275

(22) PCT Filed: Mar. 2, 2022
(86) PCT No.: PCT/NL2022/050116

§ 371 Date: Aug. 29, 2023

(30) Foreign Application Priority Data
Mar. 2, 2021 (EP) 21160302.2

(51) Int. Cl. A23J 3/22; A23J 3/16; A23J 3/18; A23L 35/00

(52) U.S. Cl. CPC A23J 3/227; A23J 3/16; A23J 3/18; A23L 35/10

(57) ABSTRACT

The invention provides a method for preparing a meat substitute, comprising a) preparing a binding emulsion comprising water, a lipid, and a binder comprising native patatin; b) combining the binding emulsion with a denatured protein and optional ingredients; and c) shaping the meat substitute, and a meat substitute obtained using the said method. It has been found that by following the present method, meat substitutes with increased adhesion and hardness can be obtained.

The invention is in the field of meat substitutes.

### BACKGROUND

Meat products are an important source of proteins, but are associated with many disadvantages. They pose a high burden on the environment, compromise animal welfare and have the potential to cause negative health effects in humans (e.g. high cholesterol, saturated fat). Therefore, vegan and vegetarian diets have become increasingly more popular, which trend has fueled the research to develop further alternatives for meat.

Nowadays, appropriate vegetarian and vegan alternatives to real meat products are available, which are typically comprised of plant proteins such as textured vegetable protein (TVP) and plant-based lipids, bound together with a suitable binder. The binder plays a crucial role as the binder should effectively bind the ingredients together such that the product can be shaped into a desired form. Further, the binder should allow formation of a product which can be transported and stored, and which allows for cooking the product.

Two generic types of meat substitutes may be distinguished. One type of meat substitute is the ready-to-eat type, which is cooked during the production process. This type of product can be consumed as-is or after re-heating by a consumer.

The second type of meat substitute is the “raw-type” meat substitute. A raw-type meat substitute mimics animal-derived meat in that it has not been cooked during production. A heating step prior to consumption is necessary. Normally, raw-type meat substitutes undergo a change in appearance during cooking; they may “bleed” such as described in WO2017/070303, and will brown and display Maillard-type reactions similar to animal-derived meat, mimicking cooking with animal-derived meat.

A raw-type meat substitute is considered more attractive than a ready-to-eat type meat substitute, because the barrier for meat eaters to switch to a raw-type meat substitute is conceived as lower. In addition, flavor, texture, and appearance of a raw-type meat substitute is considered more attractive. However, raw-type meat substitutes pose additional challenges to the product in terms of flavor, composition and shelf life.

Various binders for meat substitutes are known. Binders may be starch-based, protein based or based on gums or hydrocolloids, among others. Among the types of binders, protein binding is considered attractive because the presence of protein increases protein content, and because it results in a relatively natural flavor and mouth feel. In addition, during cooking, the protein denatures in a process highly similar to protein denaturation which occurs during the cooking of animal-derived meat.

It is well known that there are various types of protein which are suitable as binder. One very attractive potential protein binder is patatin, as patatin has high gel strength at relatively low concentration. Patatin makes up about 40% of the protein in potato tubers (Solanum tuberosum), and naturally functions as a storage protein. Patatin is known to have good gelling and emulsification properties, and binding of food products in general with patatin is known. For example, WO 2008/069650 describes the isolation of native patatin from potato, and its use as a gelling protein and/or emulsifier in various food products.

Binding with patatin was conventionally achieved by mixing the patatin as a solution or a dry powder with the ingredients which require binding. This however in some cases resulted in a less than optimal adhesion. It has now been found that adhesion does not correlate with gel strength for 100%, as the quantity and type of other ingredients impact the adhesion as well, as does the method which is used to combine the ingredients.

### FIGURES

FIG. 1: adhesion (a) and hardness (b) of meat substitutes M.S.1, M.S.2 and M.S.3, as compared to COMP1.

FIG. 2: adhesion (a) and hardness (b) of meat substitutes M.S.4, M.S.5 and M.S.6, as compared to COMP2 and COMP3.

### THE INVENTION

The invention discloses a method for preparing a meat substitute, comprising preparing a binding emulsion comprising water, a lipid, and a binder comprising native patatin, b) combining the binding emulsion with a denatured protein and optional ingredients, and c) shaping the meat substitute.

It has been found that in patatin-bound meat substitutes, binding is best achieved by combining the ingredients with a binding emulsion comprising water, a lipid, and a binder comprising native patatin. By first preparing a binding emulsion comprising water, a lipid, and a binder comprising native patatin, and subsequently combining this emulsion with the other ingredients, among which in particular the denatured protein, the adhesion of the meat substitute is improved, relative to a meat product of the same composition, but which has been prepared by combining the ingredients all at the same time, without the prior formation of a binding emulsion. The hardness of the meat substitute after cooking improves as well, by following the present method.

This insight allows to reduce the quantity of fat in the meat substitute, and to increase the quantity of denatured protein, at the same quantity of binder. This is generally considered favorable, as consumers generally prefer products with a decreased fat content.

Alternatively, the skilled person appreciates that the quantity of binder may be reduced. This may be considered favorable in terms of production cost, although it may also be considered less favorable because meat substitutes having a relatively high protein content are favored by consumers.

In some preferred embodiments, the meat substitute is prepared using a plant oil as lipid (see elsewhere). It is a further advantage of the invention that meat substitutes prepared according to the present method using one or more plant oils as lipid have higher oil holding capacity, and/or display less oil dripping. Without wishing to be bound by theory, this beneficial further effect may be related to the increased adhesion of the shaped meat substitute, and/or the increased hardness of the meat substitute after cooking.

A meat substitute, in the present context, is a product which resembles animal-derived meat, but which is prepared using mainly plant-based ingredients. A meat substitute is thus suitable for vegetarians, and may depending on the actual ingredients used, also be suitable for a vegan lifestyle.

A vegetarian meat substitute is a meat substitute which does not include meat derived from a mammal or a bird, but which may include meat derived from a fish or a crustacean such as shrimp or shellfish, and which may furthermore include non-meat animal derived products (products which do not require sacrification of animals), such as milk, cream or egg. In preferred embodiments, a vegetarian meat substitute comprises no meat which has been derived from a mammal, bird, fish or crustacean, but which may comprise non-meat animal-derived products such as milk, cream or egg.

A vegan meat substitute is a meat substitute which does not include any animal-derived products. A vegan meat substitute comprises only plant-based ingredients.

Preferably, the meat substitute is a non-meat analogue of a burger, meatball, sausage, minced meat, schnitzel, skewer, nugget, rib, filet or meat chunk.

Further preferably, the method further comprises a step of packaging the meat substitute after shaping, wherein the meat substitute is a raw-type meat substitute, which defined as a meat substitute which is not heated to a temperature above 60° C. prior to packaging.

### The Denatured Protein

According to the present invention, the meat substitute is prepared from denatured protein, which is bound by a binding emulsion comprising water, a lipid, and a binder comprising native patatin.

The denatured protein can be any non-meat protein, including (for certain vegetarian products) fish or crustacean derived protein. Preferably however, the denatured protein is a denatured plant protein.

The denatured plant protein is preferably a protein derived from a tuber, cereal, nut or legume. In particularly preferred embodiments, the denatured plant protein comprises one or more types of protein selected from the group consisting of soy protein, pea protein, wheat protein/ gluten, potato protein, faba bean protein, mungbean protein, hemp seed protein, mushroom protein, sesame seed protein, sweet potato protein, chick pea protein, lentil protein, oat protein and spelt protein, most preferably soy protein or pea protein.

The denatured plant protein is preferably a coagulated protein, such as a protein obtained by acid or heat coagulation. The skilled person can obtain denatured plant protein by generally known methods.

In much preferred embodiments, the denatured plant protein is a texturized plant protein. Texturized plant protein is well-known, and commercially available. Texturized plant protein is a plant-based protein which has been subjected to a step of extrusion, which provides the protein with a meat-like fibrous structure. In much preferred embodiments, the texturized plant protein is a texturized pea protein, a texturized soy protein, a texturized potato protein or a texturized gluten.

When the denatured protein is a texturized plant protein, it is preferred that the texturized protein is hydrated prior to combination with the binding emulsion. In such embodiments, the texturized plant protein is first mixed with water to effect hydration, and subsequently combined with the binding emulsion as well as any other optional ingredients.

When the denatured protein is a texturized plant protein, the texturized plant protein may be a single type of texturized plant protein, or a mixture of two or more types of texturized plant protein. In preferred embodiments, the denatured protein is a combination of texturized soy protein and texturized gluten protein. In such embodiments, the weight ratio between texturized soy protein and texturized gluten protein is preferably 1:1-10:1, preferably 1:2-1:8, most preferably 1:3-1:6.

### The Binding Emulsion

The binding emulsion comprises water, a lipid, and a binder comprising native patatin. Water is generally available, and must be suitable for human consumption. Mains water is preferred.

The lipid is defined as glycerol moieties substituted with one or more fatty acids. The lipid is preferably a triglyceride, in which at least 98%, preferably at least 99% of the glycerol moieties is substituted with three fatty acids.

The lipid to be provided to the mixture is preferably as pure as possible. That is, the quantity of free fatty acids (“FFA”) in the lipid is preferably less than 18 mmol per kg lipid, more preferably less than 9 mmol per kg lipid, even more preferably less than 3 mmol per kg lipid. The quantity of free fatty acids in the lipid can be determined by a chemical titration method, as described below.

Additionally or alternatively, the total quantity of diacylglycerols (“DAG”) and monoacylglycerols (“MAG”) in the lipid to be provided to the mixture is preferably less than 10 wt. %, more preferably less than 6 wt. %, even more preferably less than 4 wt. %, relative to the total lipid. The quantity of DAG and MAG in the lipid can be determined by column chromatography or capillary gas chromatography as described in “Standard Methods for the Analysis of Oils, Fats and Derivatives”, 1^{st} supplement to the 7^{th} edition (IUPAC, 1987).

The lipid can be solid or liquid, but preferably, the lipid is liquid. Colloquially, a liquid lipid is called an oil, and a solid lipid is called a fat. Preferably, the lipid is an oil, preferably a plant oil, such as a seed oil, nut oil, or fruit oil.

An oil is a lipid which is liquid or viscous at 20° C. (under atmospheric pressure). Liquid or viscous is a term which reflects the capability to flow under the influence of gravity. A liquid lipid may thus also be described as “free-flowing”, which means that the lipid can be poured from a vessel at temperatures around room temperature (20° C.).

Fat is a lipid which is solid at room temperature (20° C.) (under atmospheric pressure). Solid in this context is defined as the capability to maintain a particular shape for at least 24 hours in the absence of support. If pressure is applied above atmospheric pressure, a solid lipid may change shape, which changed shape can be maintained for at least 24 hours after the pressure has been applied, without support.

Particularly preferred lipids comprise one or more of the lipids in the group of plant oils, such as corn oil, soybean oil, rapeseed oil, sunflower oil, grape seed oil, peanut oil, sesame oil, olive oil, shea butter, cocoa butter, and rice bran oil, most preferably sunflower oil. In optional embodiments, the lipid may be partially hydrogenated.

In much preferred embodiments, at least 94 wt. %, preferably at least 95 wt. % of the fatty acids of the lipid has a fatty acid chain length of C16 or more, relative to the total weight of the fatty acids.

In further much preferred embodiments, the total of C12-C16 fatty acids in the lipid is less than 15 wt. %, relative to the total weight of the fatty acids.

These fatty acid profiles have the advantage of being less susceptible to hydrolysis by patatin. It is a distinct advantage of this fatty acid profile that off-flavor formation during storage is significantly reduced, which ensures that the meat substitute of the invention has an acceptable shelf life.

The binder furthermore comprises native patatin. Native patatin is a protein which occurs in tubers, in particular tubers of potato (Solanum tuberosum). The skilled person is aware which of the protein in a tuber can be considered patatin.

Patatin is a protein which is naturally present in the tuber as storage protein. Storage protein is protein which functions as a store for nitrogen, sulphur and/or carbon, enabling the plant to survive periods of adverse growth conditions or between growing seasons.

Storage protein, which is the same as patatin in the present context, is generally present in a quantity of 40-50 wt. % of all protein in the tuber. Storage protein can generally be characterized by a molecular weight of 35-50 kDa, preferably 38-45 kDa and/or by an isoelectric point of 4.8-5.6. The molecular weight can be determined by commonly known methods, such as SDS page. The isoelectric point can also be determined by commonly known methods, such as for example isoelectric focusing.

In the present context, the binder comprises native patatin. Native means that the protein has its natural function and three-dimensional structure. Native protein has not been denatured, such as by coagulation, and maintains solubility and reactivity.

Native patatin can be isolated from potato tubers, or from other potato-derived processing streams such as potato juice (for example the juice obtained as a side product in potato starch manufacturing), or potato cutting water (the processing water which is obtained when potatoes are being shaped for consumption as for example fries or chips). One particularly convenient method to isolate native patatin has been described in WO2008/069650, although the skilled person can obtain native patatin by other methods. In addition, native patatin is commercially available.

The binder comprises, by wt. % of total protein, at least 35 wt. % of patatin, preferably at least 40 wt. %. In embodiments where there is from 35 up to 60 wt. % of patatin, relative to total protein, the binder can be called a total tuber protein isolate.

In further preferred embodiments, the binder comprises, by wt. % of total protein, at least 75 wt. % of patatin, preferably at least 80 wt. %. In embodiments where there is 60 wt. % or more up to 85 wt. % of potato storage protein, relative to total protein, the binder can be called a high molecular weight (HMW) isolate comprising patatin.

In further preferred embodiments, the binder comprises, by wt. % of total protein, at least 90 wt. %, more preferably at least 95 wt. % of patatin. In embodiments where there is 90 wt. % or more up to and including 100 wt. % of patatin, relative to total protein, the binder can be called a patatin isolate.

In much preferred embodiments, the binder consists of native patatin as the sole native protein. In further preferred embodiments, the binding emulsion comprises native patatin as the only binder. In preferred embodiments, the binding emulsion does not comprise a hydrocolloid. In other preferred embodiments, the binding emulsion does not comprise non-potato derived binding protein.

The binder is preferably provided to the binding emulsion in the form of a protein isolate comprising native patatin. Said protein isolate is preferably a native protein powder. The binder preferably comprises a total quantity of at least 75 wt. %, preferably at least 85 wt. %, of native protein, relative to dry matter.

Preferably, the binding emulsion comprises 15-30 wt. % of binder. Preferably, the binding emulsion comprises 15-30 wt. % native patatin, preferably 16-26 wt. %. Further preferably, the weight ratio of lipid to water in the binding emulsion is 3:1-1:3, preferably 2:1-1:2, more preferably 1.5:1-1:1.5.

In much preferred embodiments, the binding emulsion comprises patatin, lipid and water in a weight ratio of 1:(1-4):(1-4), preferably 1:(1.5-3.5):(1.5-3.5). In much preferred embodiments, the weight of the lipid in the binding emulsion is about equal to the weight of the water, about equal being defined as 80-120%, preferably 90-110%, more preferably 95-105%.

### The Further Ingredients

In preferred embodiments, the meat substitute may additionally include various other optional ingredients, in order to enhance taste, appearance texture, mouthfeel and the like. Preferably, the meat substitute includes one or more salts, such as salts selected from the group consisting of sodium, potassium or calcium chloride, sodium or potassium glutamate and calcium sulfate. Salts may be present in a quantity of for example 0.1-5 wt. %, preferably 0.5-2.5 wt. %, relative to the total weight of the meat substitute. In much preferred embodiments, the meat substitute comprises 0.1-3 wt. % sodium chloride, preferably 0.5-2 wt. %, relative to the total weight of the meat substitute.

Also, the meat substitute may include pigments, such as heme-like pigment, red beet pigment, carotene, caramel, beet juice extract, tomato pigment, radish pigment, paprika pigment and/or amaranth. The quantity of pigment varies with the type of pigment used, and can be determined by routine experiments.

In preferred embodiments, the meat substitute furthermore includes one or more fibers, in particular dietary fibers, such as selected from the group consisting of potato fiber, sweet potato fiber, carrot fiber, psyllium fiber, bamboo fiber, soybean fiber, pea fiber, mungbean fiber, tapioca fiber, coconut fiber, banana fiber, cellulose, resistant starch, resistant dextrins, inulin, lignin, chitin, pectin, beta-glucan, and oligosaccharide. The quantity of fiber, if present, can be 0.1-10 wt. %, preferably 0.5-7.5 wt. %, more preferably 1-5 wt. %, relative to the total weight of the meat substitute. In much preferred embodiments, the fiber is a plant-derived dietary fiber, such as potato fiber, sweet potato fiber, carrot fiber, psyllium fiber, bamboo fiber, soybean fiber, pea fiber, mungbean fiber, tapioca fiber, coconut fiber, banana fiber or cellulose. In further preferred embodiments, the meat substitute does not comprise a fiber.

Also, texturisers such as native starch, modified starch, cellulose derivatives, carrageenan, alginate, agar, konjac, xanthan, and pectin may optionally be included in the meat substitute, preferably at a quantity of 1-10 wt. %, preferably 1.5-5 wt. %, relative to the total weight of the meat substitute. In other preferred embodiments, a texturizer is not present.

Furthermore preferred is to include flavor development aids, such Maillard-active ingredients, among which for example dextrose, ribose and maltodextrin. Flavor development aids can be present in a quantity of 0.1-5 wt. %, preferably 0.2-2 wt. %, relative to the total weight of the meat substitute.

Also other flavorings can be present in the mixture, such as for example a sweetener selected from the group consisting of sucrose, glucose, fructose, syrup, and artificial sweeteners.

In preferred embodiments, the meat substitute does not comprise a hydrocolloid, such as alginate, agar, konjac, xanthan, pectin or carrageenan. In further preferred embodiments, the meat substitute does not comprise a gelling non-starch carbohydrate, such as such as cellulose derivatives, in particular methylcellulose or carboxy methyl cellulose. In further preferred embodiments, the meat substitute does not comprise a modified starch.

### Preparation of the Meat Substitute

The present meat substitute is prepared by preparing a binding emulsion comprising water, a lipid, and a binder comprising native patatin. The binding emulsion is prepared by mixing the appropriate quantities of binder, water and lipid under conditions which result in emulsification. Such methods are commonly known, and include high shear mixing, for example in a Thermomix, Stephan cutter, bowl chopper, or in a suitable vessel equipped with a blender.

The binding emulsion is then combined with a denatured protein. In embodiments where the denatured protein is a texturized plant protein, the texturized plant protein is preferably hydrated prior to combination with the binding emulsion. Said combining can achieved by commonly known means, such as by mixing and homogenization, tumbling or any other suitable means which result in appropriate mixing of the binding emulsion and the denatured protein.

The further optional ingredients can be included at any time. The binding emulsion may be combined with a mixture of denatured protein and optional ingredients, or the binding emulsion may first be combined with the denatured protein, which is subsequently combined with further optional ingredients, in any order. In much preferred embodiments, the step of combining the binding emulsion with a denatured protein and optional ingredients results in a homogenous mixture of all ingredients.

The homogenous mixture described above is subsequently shaped into a desired shape. The shape is determined by the type of meat substitute. Any shape can be used, although in order to attract consumer preference, the chosen shape is preferably customary for the type of meat substitute in question. For example, a burger may be shaped in round disk-like shape, a sausage may be provided with a cylindrical shape, and a meat ball with a globular shape.

Shaping can be achieved by any conventional means. Preferably however, shaping is achieved by introducing the mixture into a mold of the chosen shape. Preferably, the mixture is introduced into the chosen mold, and subsequently pressed to attain a dense structure similar to animal-derived meat.

Shaping the meat substitute preferably involves cooling the meat substitute to a temperature of from −35° C. to 20° C., preferably of from −18 to 15° C., more preferably of from 0° C. to 10° C., more preferably 0-5° C. Cooling results in increased viscosity, which effects adhesion of the meat substitute. Cooling thus has the effect that the shape of the meat substitute can be maintained also without the mold.

Cooling may be achieved by any conventional means. Refrigeration is preferred. If cooling is performed to a temperature below 0° C., it is preferred that cooling is performed in two steps: first to a temperature of 0-20° C. to effect gelation of the patatin, and subsequently to a lower temperature.

The shaped meat substitute is preferably packaged after shaping. Suitable packaging for a meat substitute is generally known, and may include individual wrapping or bulk packaging, or any other conventional way of packaging a food product.

In much preferred embodiments, the method of the invention results in a raw-type meat substitute. In this embodiment, the meat substitute is not heated to a temperature above 60° C. prior to packaging. Instead, the meat substitute is cooled and generally maintained at the temperature of from −35° C. to 20° C., preferably of from −18 to 15° C., more preferably of from 0° C. to 10° C., more preferably 0-5° C., throughout the period until cooking the meat substitute. This period is the period between the production of the meat substitute and its consumption. In this period, the meat substitute is transported from the production location, to various retail shops, to the end consumer. This period is preferably 1-14 days. This is in particular true in embodiments where cooling is generally maintained at temperatures between 0° C. to 15° C.

In embodiments where cooling is maintained at temperatures below 0° C. for a longer time, the period until cooking may be prolonged by the time during which the temperature was below 0° C. The time during which the temperature is maintained below 0° C. is called the freezing time, and the freezing time may be any time, such as from one day to three years, preferably one week to one year.

Only when the meat substitute arrives at the end consumer, a raw-type meat substitute is cooked, such as at a temperature of at least 75° C. for a period of at least 1 minute.

In case the method is performed to obtain a ready-to-eat type meat substitute, the meat substitute is cooked after shaping and prior to packaging. Cooking in this case means heating to a temperature of at least 75° C. for a period of at least 1 minute.

### The Meat Substitute

The invention furthermore provides a meat substitute comprising 56-66 wt. % water, 2-7 wt. % lipid, 1-9 wt. %, preferably 1-6 wt. %, more preferably 1-4 wt. %, more preferably 1.5-3.5 wt. %, even more preferably 1.5-2.4 wt. % native patatin and 22-28 wt. % denatured protein. The ingredients of the meat substitute have been defined elsewhere; the skilled person appreciates that quantities and type of ingredients applied when preparing the meat substitute identify also the obtained meat substitute.

The meat substitute of the invention is obtainable by the method described elsewhere. The meat substitute has the advantage over known meat substitutes that it has higher adhesion and higher hardness, and also higher oil holding capacity. In addition, the present meat substitute has a generally lower fat content than known meat products, and a generally higher protein content.

In preferred embodiments, the lipid in the meat substitute is a plant oil. Preferably, the lipid is defined as glycerol moieties substituted with one or more fatty acids, wherein at least 94 wt. %, preferably at least 95 wt. % of the fatty acids has a fatty acid chain length of C16 or more, relative to the total weight of the fatty acids in the lipid. Further preferably, the total of C12-C16 fatty acids is less than 15 wt. %, relative to the total weight of the fatty acids in the lipid. Such meat substitutes have an increased shelf life.

Lipids of the indicated chain length have been found to result in the advantage that the meat substitute does not develop off-flavor upon storage in the period between production and cooking. Native patatin, apparently has at least some activity on some lipids comprising fatty acids with a chain length of C12 or higher, at least to a sufficient extent to cause off-flavors. This activity is also present on some lipids comprising fatty acids with a chain length of C14 or higher. Even lipids comprising fatty acids with a chain length of C16 or higher can be hydrolyzed by patatin to a degree which is sufficient to cause off-flavors. Patatin thus exerts activity on triglycerides with chain lengths of from C12 to C16, to such an extent that this activity causes off-flavors.

Off-flavors in the present context are defined as a lingering bitter sensation upon ingestion, which is accompanied by a stingy smell that can be described as “paint” or “vomit”. Off-flavor can preferably be determined by sensory evaluation. Off flavor can also be determined in model systems by measuring the release of free fatty acids and/or by measuring the para-anisidine value. In such cases, off-flavor can be defined as not present provided that the pAV of the lipid is maintained at 2 or less, preferably 1.5 or less, even more preferably 1 or less, and/or provided that the release of free fatty acids from the lipid is less than 50 mmol/kg oil, preferably less than 40 mmol./kg oil. The lipids that are preferably present in the present meat substitute avoid off-flavor formation.

### EXAMPLES

### Preparation of a Binding Emulsion

Binding emulsions were prepared using a Thermomix. Alternatively, a T18 Ultraturrax with T18N (10 or 19 g) dispersing tool or a T25 Ultraturrax with T25N (8 g) dispersing tool from IKA could also be used. Results with with these types of equipment are identical. For weighing, a BP3100 S balance from Satorius was used.

Water, lipid and binder were combined in the shown quantities, and subjected to emulsification to obtain a binding emulsion. The following five binding emulsions (B.E.) were used for the experiments:

| | B.E.1 | B.E.2 | B.E.3 | B.E.4 | B.E.5 |
|---|---|---|---|---|---|
| | (2:3:3) | (2:4:4) | (2:5:5) | (2:3:3) | (3:5:5) |
| Binder [g] | 150 | 100 | 100 | 150 | 150 |
| Water [g] | 225 | 200 | 250 | 225 | 250 |
| Lipid [g] | 225 | 200 | 250 | 225 | 250 |
| lipid type | sun- | sun- | sun- | coconut | sun- |
| | flower | flower | flower | fat | flower |
| | oil | oil | oil | | oil |

### Example 1: Adhesion and Hardness of Meat Substitutes Prepared Using a Binding Emulsion

### Preparation of Meat Substitutes

Meat substitutes were prepared using identical ingredients, using the present method (M.S.), or by combining all ingredients without the prior formation of a binding emulsion (COMP). In all meat substitutes except COMP3, the quantity of binder (pure native patatin, Solanic 200®, Avebe) was 2 wt. %, relative to the total weight of the meat substitute. Fiber, if present, is Paselli FP from Avebe.

Meat substitutes were prepared by hydrating the texturized plant protein (Soy TVP “Tradcon T”, Soy protein a.d., Serbia) and gluten TVP (“Unitex S2030”, Vitablend Nederland) for a period of one hour in the quantity of water listed as “TVP hydration water”.

The hydrated texturized plant protein including any remnant TVP hydration water was combined with a quantity of binding emulsion so as to provide the quantity of lipid, patatin and water listed in the below tables. Any further ingredients (e.g. sodium chloride, additional water and lipid) were added after the combination of the binding emulsion with the hydrated TVP.

For comparative experiments, the same type and quantity of pure native patatin in powder form as well as the listed quantities of salt, lipid and water were combined and mixed without prior formation of a binding emulsion. Combining and mixing was performed in a Hobart mixer. Subsequently, the meat substitutes were shaped into a burger patty, which was cooled to a temperature of 4° C. for a period of 24 hours. The meat substitutes were packaged for storage, where necessary.

After shaping and packaging where applicable, the meat substitutes were cooked by frying in a frying pan at a temperature of 75-80° C.

The following meat substitutes were prepared:

Group A: comparative meat substitutes (COMP), not prepared using a binding emulsion.

| | COMP1 | | COMP2 | | COMP3 | |
|---|---|---|---|---|---|---|
| Ingredients | wt. % | g | wt. % | g | wt. % | g |
| Soy TVP | 22 | 110 | 20 | 100 | 20 | 100 |
| Gluten TVP | 4 | 20 | 3 | 15 | 3 | 15 |
| TVP hydration | 59 | 295 | 52 | 260 | 52 | 260 |
| water | | | | | | |
| Water | 5 | 25 | 10 | 50 | 9 | 45 |
| Sunflower oil | 7 | 35 | 10 | 50 | 10 | 50 |
| Solanic 200 | 2 | 10 | 2 | 10 | 3 | 15 |
| Fiber | 0 | 0 | 2 | 10 | 2 | 10 |
| Sodium salt | 1 | 5 | 1 | 5 | 1 | 5 |
| TOTAL | 100 | 500 | 100 | 500 | 100 | 500 |

Group B: meat substitutes (M.S.) prepared using a binding emulsion. The binding emulsion was used in the indicated quantity, resulting in the indicated quantities of lipid, water and patatin. Further lipid and water was added separately with the further optional ingredients, making M.S.1, M.S.2 and M.S.3 recipes with identical constituents to COMP1, but prepared using the specified binding emulsions rather than by individual addition and mixing of all ingredients.

| | without fiber | | | | | |
|---|---|---|---|---|---|---|
| | M.S.1 | | M.S.2 | | M.S.3 | |
| Ingredients | wt. % | g | wt. % | g | wt. % | g |
| Soy TVP | 22 | 110 | 22 | 110 | 22 | 110 |
| Gluten TVP | 4 | 20 | 4 | 20 | 4 | 20 |
| TVP hydration | 59 | 295 | 59 | 295 | 59 | 295 |
| water | | | | | | |
| Water | 2 | 10 | 1 | 5 | 0 | 0 |
| Sunflower oil | 4 | 20 | 3 | 15 | 2 | 10 |
| Sodium salt | 1 | 5 | 1 | 5 | 1 | 5 |
| B.E.1 (2:3:3)^{#1} | 8 | 40 | | | | |
| B.E.2 (2:4:4)^{#2} | | | 10 | 50 | | |
| B.E.3 (2:5:5)^{#3} | | | | | 12 | 60 |
| TOTAL | 100 | 500 | 100 | 500 | 100 | 500 |

^{#1}40 g B.E.1 corresponds to 10 g (2 wt. %) patatin, 15 g (3 wt. %) sunflower oil and 15 g (3 wt. %) water.
^{#2}50 g B.E.2 corresponds to 10 g (2 wt. %) patatin, 20 g (4 wt. %) sunflower oil and 20 g (4 wt. %) water.
^{#3}60 g B.E.3 corresponds to 10 g (2 wt. %) patatin, 25 g (5 wt. %) sunflower oil and 25 g (5 wt. %) water.

Group C: meat substitutes (M.S.) prepared using a binding emulsion. The binding emulsion was used in the indicated quantity, resulting in the indicated quantities of lipid, water and patatin. Further lipid and water was added separately with the further optional ingredients, making M.S.4 and M.S.5 recipes with identical constituents to COMP2, but prepared using the specified binding emulsions rather than by individual addition and mixing of all ingredients. Similarly, M.S.6 compares to COMP3.

| | with fiber | | | | | |
|---|---|---|---|---|---|---|
| | M.S.4 | | M.S.5 | | M.S.6 | |
| Ingredients | wt. % | g | wt. % | g | wt. % | 60 |
| Soy TVP small | 20 | 100 | 20 | 100 | 20 | 100 |
| granule | | | | | | |
| Gluten TVP | 3 | 15 | 3 | 15 | 3 | 15 |
| TVP hydration | 52 | 260 | 52 | 260 | 52 | 260 |
| water | | | | | | |
| Water | 7 | 35 | 6 | 30 | 4 | 20 |
| Sunflower oil | 7 | 35 | 6 | 30 | 5 | 25 |
| PaselliFP | 2 | 10 | 2 | 10 | 2 | 10 |
| Sodium salt | 1 | 5 | 1 | 5 | 1 | 5 |
| B.E.1 (2:3:3)^{#4} | 8 | 40 | | | | |
| B.E.2 (2:4:4)^{#5} | | | 10 | 50 | | |
| B.E.5 (3:5:5)^{#6} | | | | | 13 | 65 |
| TOTAL | 100 | 500 | 100 | 500 | 100 | 500 |

^{#4}40 g B.E.1 corresponds to 10 g (2 wt. %) patatin, 15 g (3 wt. %) sunflower oil and 15 g (3 wt. %) water.
^{#5}50 g B.E.2 corresponds to 10 g (2 wt. %) patatin, 20 g (4 wt. %) sunflower oil and 20 g (4 wt. %) water.
^{#6}65 g B.E.5 corresponds to 15 g (3 wt. %) patatin, 25 g (5 wt. %) sunflower oil and 25 g (5 wt. %) water.

### Determination of Adhesion and Hardness

Adhesion and hardness of the meat substitute were determined using a Shimatzu EZ-SX Food Texture Analyzer (Schimatzu Corporation, Kyoto, Japan). Mechanical compression tests for both determinations applied a cylindrical probe of 75 mm diameter (SMS P/75). The meat substitutes were compressed to 60% at a constant rate of 1 mm/s.

Adhesion (J) is measured on raw, uncooked meat substitutes. Adhesion is defined as the negative area below the curve for the first peak (after the first compression).

Hardness (N) is measured in cooked meat substitutes. Hardness is defined as the highest peak force measured during first compression.

### Results

Adhesion and hardness of the burgers are shown in the below tables:

| Without fiber | COMP1 | M.S.1 | M.S.2 | M.S.3 |
|---|---|---|---|---|
| Adhesion (J) | 0.0028 | 0.0034 | 0.0042 | 0.0037 |
| Hardness (N) | 174.227 | 192.439 | 182.866 | 174.816 |

| With fiber | COMP2 | COMP3 | M.S.4 | M.S.5 | M.S.6 |
|---|---|---|---|---|---|
| Adhesion (J) | 0.0038 | 0.0051 | 0.0063 | 0.0086 | 0.0113 |
| Hardness | 149.307 | 189.580 | 158.854 | 145.836 | 201.961 |
| (N) | | | | | |

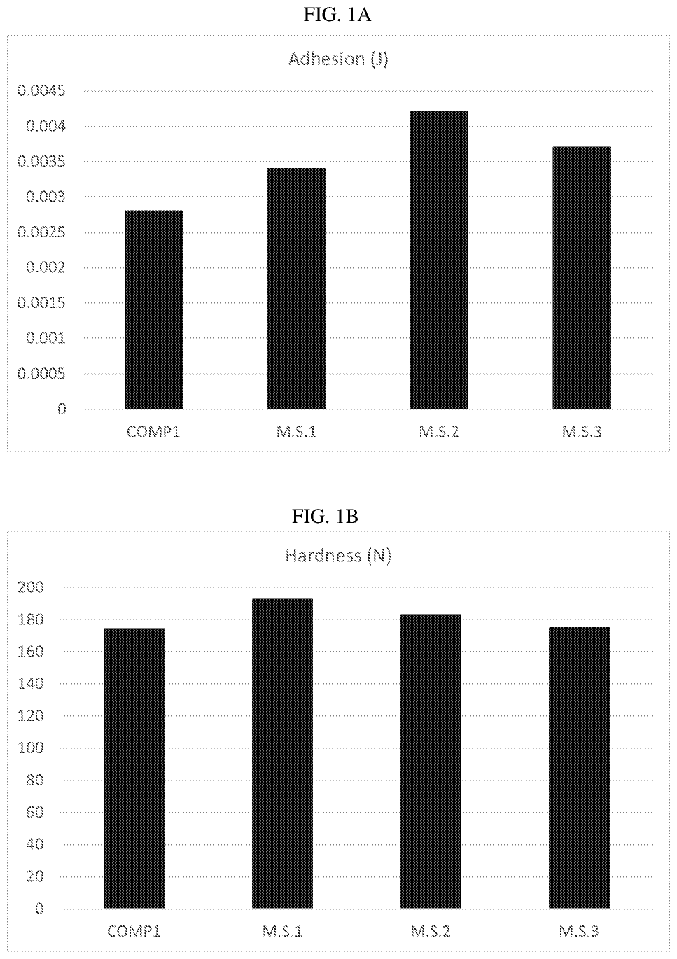

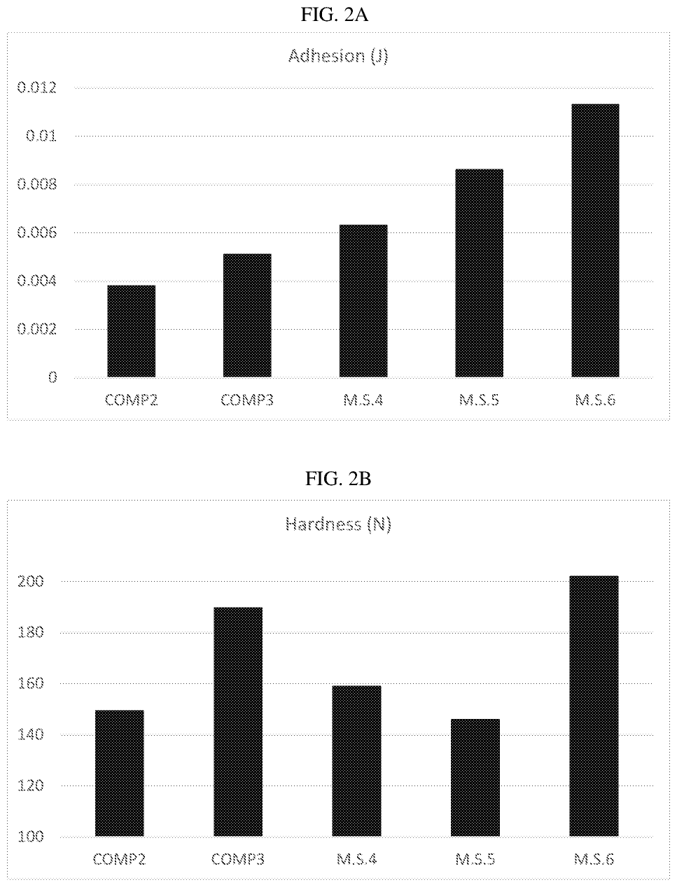

The results show that adhesion and hardness of the meat substitute improves when the lipid and the patatin binder are first combined in a binding emulsion, and subsequently combined with the additional ingredients. The results are depicted graphically in FIGS. 1 and 2.

### Example 2: Off-Flavour Formation in Meat Substitutes Based on Different Lipids

Determination of Para-Anisidine Value (pAV) of Lipids

Secondary oxidation products were determined by measuring the para-Anisidine value (pAV) according to the method of the American Oil Chemists Society (AOCS, 2004, Official method Cd. 18-90 in: Official methods and recommended practices of the American Oil Chemists Society). This method detects fatty aldehydes, in particular unsaturated ones. The p-anisidine value is defined as 100 times the optical density measured at 350 nm in a 1 cm cuvette of a solution containing 1.00 g of the oil in 100 mL of a mixture of solvent and para-anisidine reagent (20 mM para-anisicline, SigmaAldrich A88255).

### Determination of Fatty Acid Composition by Gas Chromatography

The fatty acid composition of a lipid was determined by GC, on the basis of full lipid hydrolysis and conversion of the fatty acids to methyl esters.

A lipid sample of about 5 mg was weighed in a 20 ml glass tube, to which there was added 2 ml methanol containing 50 M NaOH. The tube was closed, and incubated for 30 min at 70° C. in a block heater. After cooling to room temperature, 3 ml 20% BF₃ reagent in MeOH was added to the tube, effecting methylation of the fatty acids to obtain fatty acid methyl esters (FAME's).

The samples were cooled to room temperature, whereupon 5 ml saturated aqueous NaCl and 2.5 ml n-hexane was added. The tube was closed and vortexed for 1 min and mixed for 15 min with a test tube rotator. From the top hexane layer, there was taken 2 ml, which was transferred to the GC.

| Column | Stabil Wax-Da, 30 m × 0.32 mm, 0.25 μm | |
|---|---|---|
| Oven | 50° C. for 2 min, ramp 16° C./min to 250° C. and hold 13 | |
| | min isotherm at 250° C. | |
| injector | PTV 250° C., flow: 1.2 ml/min, splitless flow: 50 ml/min, | |
| | splitless time: 0.8 min | |
| Run Time | Total run time is 30 min. | |
| Injection volume | 1 μl | |
| MS | Fullscan(TIC) = 30-450 amu, dwell/scan time: 0.2 sec | |
| Retention time FAME's | FA_C12:0 10, 63 | FA_C18:3 15, 32 |
| (FA) (minute) | FA_C14:0 12, 03 | FA_C20:0 15, 70 |
| | FA_C16:0 13, 29 | FA_C20:1 15, 90 |
| | FA_C18:0 14, 46 | FA_C22:0 17, 39 |
| | FA_C18:1 14, 63 | FA_C22:1 17, 69 |
| | FA_C18:2 14, 91 | FA_C24:0 19, 90 |

### Determination of Free Fatty Acid Content

Titrimetry can be used to determine the free fatty acid content of lipids. The method is based on chemical titration method published by the Cyberlipid Center (Leray).

A solvent mixture (ethanol/tert-Butyl methyl ether, 1/1, v/v) was prepared and 10 ml phenolphthalein solution was added. As titrant a 10 mM KOH in ethanol solution was prepared.

The lipid was extracted using hexane. The hexane layer was transferred by a glass pipet to a 100 ml Erlenmeyer with cap. Solvent mixture was added to obtain approximately 30-50 ml solution. Titrant was added while stirring the solution on a magnetic stirrer to the end point of the indicator (light purple colour persisting for few seconds). The amount of titrant added was determined by weighting the Erlenmeyer before and after titrant addition. The weight was used to calculate the mmol alkaline/kg of oil was used. The value was corrected for the blank.

$$Equation = \frac{{m}_{titrant} * {M}_{titrant}}{{m}_{oil}} * 1000 = mmol KOH / kg oil$$

in which mₜᵢₜᵣₐₙₜ is mass of titrant added to sample in g, Mₜᵢₜᵣₐₙₜ is the molar mass in mmol KOH/g titrant and mₒᵢₗ is the mass of oil in the sample in g.

### Experimental

Off-flavor formation was modelled for two meat substitutes. One meat substitute is based on coconut fat, and the other meat substitute is based on sunflower oil. The fatty acid (FA) composition of these two lipids is provided in the following table.

| | Coconut fat | Sunflower oil |
|---|---|---|
| | wt. % of FA | wt. % of FA |
| FA | (m/m) | (m/m) |
| C4:0 | ND | ND |
| C6:0 | ND | ND |
| C8:0 | 12.5 | ND |
| C10:0 | 10.5 | ND |
| C12:0 | 29.7 | ND |
| C14:0 | 16.7 | ND |
| C16:0 | 10.4 | 11.5 |
| C18:0 | 5.0 | 9.0 |
| C18:1 | 9.1 | 32.5 |
| C18:2 | 3.7 | 38.7 |
| C18:3 | ND | ND |
| C20:0 | ND | 0.9 |
| C20:1 | ND | 0.8 |
| C22:0 | ND | 2.5 |
| C22:1 | ND | ND |
| C24:0 | ND | 0.8 |
| Rest FA | 2.5 | 3.4 |
| total =>C16 | 28.2 | 96.6 |
| total C12-C16 | 56.8 | 11.5 |

Modelling was performed by preparing a model emulsion from a 33 g/l demiwater solution of patatin (Solanic 200®, Avebe) and an equal amount by weight of the lipid. The lipid and water were emulsified by means of an ultraturrax (T18 Ultraturrax with T18N dispersing tool) operating at 10 krpm for 1 minute and these emulsions were incubated at either ambient temperature (20° C.±0.2° C.) or at 40° C. for one day under mild agitation. Blanks were measured at room temperature.

The quantity of released fatty acids (mmol FFA/kg oil), as well as the pAV of the emulsion was determined after incubation at 20 or 40° C.

Model burgers prepared using the lipids sunflower oil and coconut fat were evaluated sensorically. Sensoric testing was performed by a panel of trained sensoric testers. Tests were performed immediately after preparation, and after two days of storage at room temperature, mimicking an accelerated cool storage period.

Model burgers which were compared by sensoric testing included:

| | |
|---|---|
| M.S.7 | M.S.1 |

| Ingredients | wt. % | g | wt. % | g |
|---|---|---|---|---|
| Soy TVP | 22 | 110 | 22 | 110 |
| Gluten TVP | 4 | 20 | 4 | 20 |
| TVP hydration water | 59 | 295 | 59 | 295 |
| Water | 2 | 10 | 2 | 10 |
| Coconut fat | 4 | 20 | 0 | 0 |
| Sunflower oil | 0 | 0 | 4 | 20 |
| Sodium salt | 1 | 5 | 1 | 5 |
| B.E.4 (2:3:3)^{#7} | 8 | 40 | | |
| B.E.1 (2:3:3)^{#8} | | | 8 | 40 |
| TOTAL | 100 | 500 | 100 | 500 |

^{#7}40 g B.E.4 corresponds to 10 g (2 wt. %) patatin, 15 g (3 wt. %) coconut fat and 15 g (3 wt. %) water.
^{#8}40 g B.E.1 corresponds to 10 g (2 wt. %) patatin, 15 g (3 wt. %) sunflower oil and 15 g (3 wt. %) water.

### Results

The quantity of fatty acids which is released in the model emulsions, and the pAV, are shown in the below table.

| | Patatin/ | Incubation | mmol | |
|---|---|---|---|---|
| Substrate | blank | temperature | FFA/kg oil | pAV |
| Coconut fat | Blank | 20° C. | 2 | 0.13 |
| Coconut fat | patatin | 20° C. | 51 | 0.15 |
| Coconut fat | patatin | 40° C. | 89 | 0.76 |
| Sunflower oil | Blank | 20° C. | 2 | 0.54 |
| Sunflower oil | patatin | 20° C. | 7 | 0.57 |
| Sunflower oil | patatin | 40° C. | 15 | 0.65 |

The results obtained from the model emulsions show that a higher incubation temperature results in a higher free fatty acid content, which serves as an accelerated test to establish free fatty acid development in a meat substitute. A high free fatty acid content causes off-taste, for example by the presence of free fatty acids or by further oxidation of free fatty acids (reflected in the pAV).

It follows from the results that free fatty acid formation is minimized by using a lipid in which at least 94 wt. % of the fatty acids has a fatty acid chain length of C16 or more, relative to the total weight of the fatty acids, and/or wherein the total of C12-C16 fatty acids is less than 15 wt. %, relative to the total weight of the fatty acids.

Sensoric testing of the model burgers showed that the meat substitute based on coconut fat (a lipid in which less than 94 wt. % of the fatty acids has a fatty acid chain length of C16 or more, relative to the total weight of the fatty acids, and wherein the total of C12-C16 fatty acids is more than 15 wt. %, relative to the total weight of the fatty acids) suffered considerable off-flavor already after preparation. Off-flavors intensified during storage.

In contrast, a model burger based on sunflower oil (a lipid in which more than 94 wt. % of the fatty acids has a fatty acid chain length of C16 or more, relative to the total weight of the fatty acids, and wherein the total of C12-C16 fatty acids is less than 15 wt. %, relative to the total weight of the fatty acids) did not develop off-flavor, either directly after preparation or after storage.

### Example 3: Meat Substitutes Prepared Using Various Emulsions

Meat substitutes were prepared with varying mass ratios of the binding emulsion constituents. The final burger recipe was identical to M.S.4, M.S.5 and COMP2 in example 1, and the burger was prepared using the same process steps, except that the composition of the binding emulsion was varied, and the quantities of separately added ingredients were likewise varied to arrive at the same final recipe.

| Ingredients | wt. % | g |
|---|---|---|
| Soy TVP | 20 | 100 |
| Gluten TVP | 3 | 15 |
| TVP hydration water | 52 | 260 |
| Water | 10 | 50 |
| Sunflower oil | 10 | 50 |
| Solanic 200 | 2 | 10 |
| Fiber | 2 | 10 |
| Sodium salt | 1 | 5 |
| TOTAL | 100 | 500 |

The emulsion used in this experiment were prepared on the basis of the following table, using sunflower oil as lipid.

| | B.E.6 | B.E.7 |
|---|---|---|
| | (2:2:10) | (2:2:8) |
| Binder [g] | 100 | 100 |
| Water [g] | 100 | 100 |
| Lipid [g] | 500 | 400 |

The binding emulsions had the following characteristics:

| | B.E.6 | B.E.7 |
|---|---|---|
| Protein:lipid:water | 1:1:5 | 1:1:4 |
| lipid:water | (1:5) | (1:4) |
| Amount patatin | 14% | 17% |

The prepared meat substitutes had the following characteristics:

| | |
|---|---|
| M.S.8 | M.S.9 |
| (70 g B.E.6) | (60 g B.E.7) |

| Ingredients | wt. % | g | wt. % | g |
|---|---|---|---|---|
| Soy TVP small granule | 20 | 100 | 20 | 100 |
| Gluten TVP | 3 | 15 | 3 | 15 |
| TVP hydration water | 52 | 260 | 52 | 260 |
| Water | | | 2 | 10 |
| Sunflower oil | 8 | 40 | 8 | 40 |
| PaselliFP | 2 | 10 | 2 | 10 |
| Sodium salt | 1 | 5 | 1 | 5 |
| B.E.6 (2:2:10) | 14 | 70 | | |
| B.E.7 (2:2:8) | | | 12 | 60 |
| TOTAL | 100 | 500 | 100 | 500 |

The resulting meat substitutes had the following hardness and adhesion (data for M.S.4, M.S.5 and COMP2 have been taken from example 1):

| | M.S.4 | M.S.5 | COMP2 | M.S.8 | M.S.9 |
|---|---|---|---|---|---|
| Adhesion (J) | 0.0063 | 0.0086 | 0.0038 | 0.0035 | 0.0043 |
| Hardness (N) | 158.854 | 145.836 | 149.307 | 155.522 | 144.037 |

The results show that the favorable hardness and adhesion are obtained by applying a binding emulsion as defined in claim 1.

### Example 4 (Comparative)

A binding emulsion was prepared using protein:lipid:water=5.5:8:40 (identical to 1:1.5:7). The protein used was Solanic 200 (Avebe), the lipid was sunflower oil, and the water was regular mains water.

It was found that but this emulsion is too liquid to be applied as “glue” in a burger otherwise containing the ingredients described herein (on the basis of COMP2). Adhesion and hardness could not be measured. This binding emulsion was therefore not suitable for shaping a burger.

1. A method for preparing a meat substitute, comprising
a. preparing a binding emulsion comprising water, a lipid, and a binder comprising native patatin, wherein the weight ratio of lipid to water is 3:1-1:3;
b. combining the binding emulsion with a denatured protein and optional ingredients; and
c. shaping the meat substitute.

2. A method according to claim 1, wherein the method further comprises a step of packaging the meat substitute after shaping, and wherein the meat substitute is a raw-type meat substitute, defined as a meat substitute which is not heated to a temperature above 60° C. prior to packaging.

3. A method according to claim 1, wherein the binding emulsion comprises 15-30 wt. % native patatin.

4. A method according to claim 1, wherein the weight ratio of lipid to water is 2:1-1:2.

5. A method according to claim 1, wherein the binder comprises, as wt. % of the total protein, at least 35 wt. % native patatin.

6. A method according to claim 1, wherein the lipid is defined as glycerol moieties substituted with one or more fatty acids, wherein at least 94 wt. % of the fatty acids has a fatty acid chain length of C16 or more, relative to the total weight of the fatty acids, and/or wherein the total of C12-C16 fatty acids is less than 15 wt. %, relative to the total weight of the fatty acids.

7. A method according to claim 1, wherein the lipid is liquid.

8. A method according to claim 7, wherein the lipid is a plant oil, which may optionally have been hydrogenated.

9. A method according to claim 1, wherein the lipid comprises less than 18 mmol per kg lipid of free fatty acids, and/or wherein the total of diacylglycerols and monoacylglycerols, relative to the total lipid, is less than 10 wt. %.

10. A method according to claim 1, wherein the denatured protein is a denatured plant protein comprising one or more types of protein derived from a tuber, cereal, nut or legume.

11. A method according to claim 1, wherein the denatured protein is a texturized plant protein.

12. A method according to claim 1, wherein said shaping results in a burger, meatball, sausage, minced meat, schnitzel, skewer, nugget, rib, filet, fish ball, or meat chunk.

13. A method according to claim 1, wherein the meat substitute does not comprise fibers and/or wherein the meat substitute does not comprise a hydrocolloid.

14. A meat substitute obtainable by any of the previous claims, comprising 56-66 wt. % water, 2-7 wt. % lipid, 1-9 wt. %, native patatin and 22-28 wt. % denatured protein.

15. A meat substitute according to claim 21, wherein the lipid is defined as glycerol moieties substituted with one or more fatty acids, wherein at least 94 wt. % of the fatty acids has a fatty acid chain length of C16 or more, relative to the total weight of the fatty acids, and/or wherein the total of C12-C16 fatty acids is less than 15 wt. %, relative to the total weight of the fatty acids.

16. A meat substitute obtainable by claim 1, comprising 56-66 wt. % water, 2-7 wt. % lipid, 1-6 wt. % native patatin and 22-28 wt. % denatured protein.

17. A meat substitute obtainable by claim 1, comprising 56-66 wt. % water, 2-7 wt. % lipid, 1-4 wt. % native patatin and 22-28 wt. % denatured protein.

18. A meat substitute obtainable by claim 1, comprising 56-66 wt. % water, 2-7 wt. % lipid, 1.5-3.5 wt. % native patatin and 22-28 wt. % denatured protein.

19. A meat substitute according to claim 16, wherein the lipid is defined as glycerol moieties substituted with one or more fatty acids, wherein at least 95 wt. % of the fatty acids has a fatty acid chain length of C16 or more, relative to the total weight of the fatty acids, and/or wherein the total of C12-C16 fatty acids is less than 15 wt. %, relative to the total weight of the fatty acids.

20. A method according to claim 1, wherein the weight ratio of lipid to water is 1.5:1-1:1.5.

21. A method according to claim 1, wherein the binder comprises, as wt. % of the total protein, at least 75 wt. % native patatin.

22. A method according to claim 1, wherein the lipid is defined as glycerol moieties substituted with one or more fatty acids, wherein at least 95 wt. % of the fatty acids has a fatty acid chain length of C16 or more, relative to the total weight of the fatty acids, and/or wherein the total of C12-C16 fatty acids is less than 15 wt. %, relative to the total weight of the fatty acids.

23. A method according to claim 7, wherein the lipid is, preferably selected from the group consisting of corn oil, soybean oil, rapeseed oil, sunflower oil, grape seed oil, peanut oil, sesame oil, olive oil, shea butter, cocoa butter, and ricebran oil, which may optionally have been hydrogenated.

24. A method according to claim 1, wherein the denatured protein is a denatured plant protein comprising one or more types of protein derived from a tuber, cereal, nut or legume, which protein is selected from the group consisting of soy protein, pea protein, wheat protein/gluten, potato protein, faba bean protein, mungbean protein, hemp seed protein, mushroom protein, sesame seed protein, sweet potato protein, chick pea protein, lentil protein, oat protein and spelt protein.

25. A method according to claim 1, wherein the denatured protein is a hydrated texturized plant protein.
